(19) United States
(12) Patent Application Publication
(10) Pub. No.: US 2025/0292956 A1
(43) Pub. Date: Sep. 18, 2025

(54) MAGNETIC COIL MODULE AND ELECTRICAL CONNECTOR INCLUDING THE MAGNETIC COIL MODULE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YONG-CHUN XU, Kunshan (CN); YUEH-SHAN SHIH, New Taipei (TW); CHIH-CHING HSU, New Taipei (TW)

(21) Appl. No.: 19/079,784

(22) Filed: Mar. 14, 2025

(30) Foreign Application Priority Data
Mar. 14, 2024 (CN) 202410294773.9

(51) Int. Cl. H01F 27/34; H01F 27/29

(52) U.S. Cl. CPC H01F 27/343; H01F 27/29

(57) ABSTRACT

A magnetic coil module includes: a first magnetic core; a second magnetic core; plural enameled wires wound on the first magnetic core to form a transformer and wound on the second magnetic core to form a common mode choke, the transformer being electrically connected to the common mode choke to form a signal transmission channel, the transformer including a center tap, the center tap including a tinned portion for forming a mechanical and electrical connection with tin; and an insulative member coated on the tinned portion to enable the magnetic coil module to withstand high voltage shock of 3KV and above.

### BACKGROUND OF THE INVENTION

### Field of the Invention

The present invention relates generally to a magnetic coil module and an electrical connector including the magnetic coil module, and more particularly to a magnetic coil module and an electrical connector resistant to high voltage shock used in the communication field.

### Description of Related Arts

U.S. Pat. No. 8,968,026 discloses an electrical connector including an insulative body and a terminal module received in the insulative body. The terminal module includes a magnetic coil assembly. The magnetic coil assembly includes a plurality of magnetic coils and a plurality of wires wound around the magnetic coils. The wires are wound to form a transformer and a common mode choke. The transformer forms a center tap when it is wound, and soldering bead is welded at the center tap to achieve mechanical and electrical connection. The soldering bead is exposed outside such that when there is an external high voltage shock, such as lightning strike, etc., the soldering bead is easy to spark with the magnetic coil or other structures inside the connector. Therefore, the connector has a poor resistance to high-voltage shock.

Therefore, an improved electrical connector is desired.

### SUMMARY OF THE INVENTION

A main object of the present invention is to provide a magnetic coil module used in the communication field, which can withstand high voltage shock.

To achieve the above object, a magnetic coil module includes: a first magnetic core; a second magnetic core; a plurality of enameled wires wound on the first magnetic core to form a transformer and wound on the second magnetic core to form a common mode choke, the transformer being electrically connected to the common mode choke to form a signal transmission channel, the transformer including a center tap, the center tap including a tinned portion for forming a mechanical and electrical connection with tin; and an insulative member coated on the tinned portion to enable the magnetic coil module to withstand high voltage shock of 3KV and above.

Another main object of the present invention is to provide an electrical connector used in the communication field, which can withstand high voltage shock.

To achieve the above object, an electrical connector includes: an insulative body; a conductive terminal received in the insulative body; and a magnetic coil module received in the insulative body and electrically connected to the conductive terminal, wherein the magnetic coil module includes a magnetic core, a plurality of enameled wires wound around the magnetic core, the enameled wires being wound around the magnetic core to form a transformer and a common mode choke, the transformer and the common mode choke forming a signal transmission channel, the transformer including a primary center tap and a secondary center tap, the secondary center tap including a tinned portion in mechanical and electrical connection by tinning, and an insulative member coated on the tinned portion.

Compared to prior art, in the present invention, the tinned portion of the center tap of the magnetic coil module and the electrical connector of the present invention is covered with an insulative member, thus, the sparking between the tinned portion at the center tap and the magnetic coil or other parts due to high voltage shock is greatly reduced.

### BRIEF DESCRIPTION OF THE DRAWING

FIG. 1 is perspective view of an electrical connector accordance with the present invention;

FIG. 2 is a perspective view of a terminal module of the electrical connector in FIG. 1;

FIG. 3 is circuit diagram of the electrical connector in FIG. 1;

FIG. 4 is a schematic diagram of the winding of the filter channel of one of the paths in the circuit diagram in FIG. 3;

FIG. 5 is a perspective view of the winding structure in FIG. 4, in which the tinned portion is not covered with insulative member; and

FIG. 6 is a perspective view of the winding structure in FIG. 4, in which the tinned portion is covered with insulative member.

### DETAILED DESCRIPTION OF THE PREFERRED EMBODIMENT

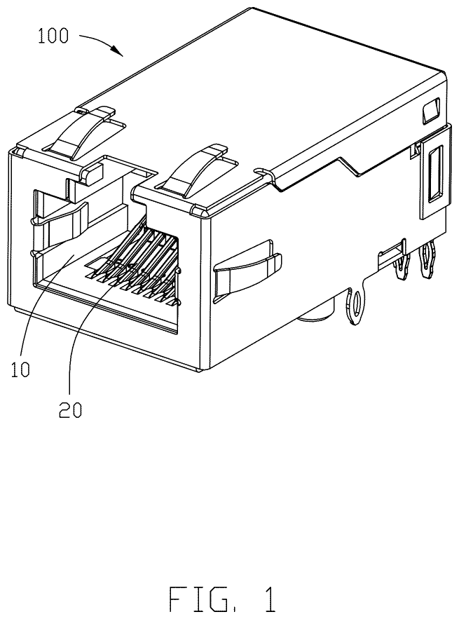

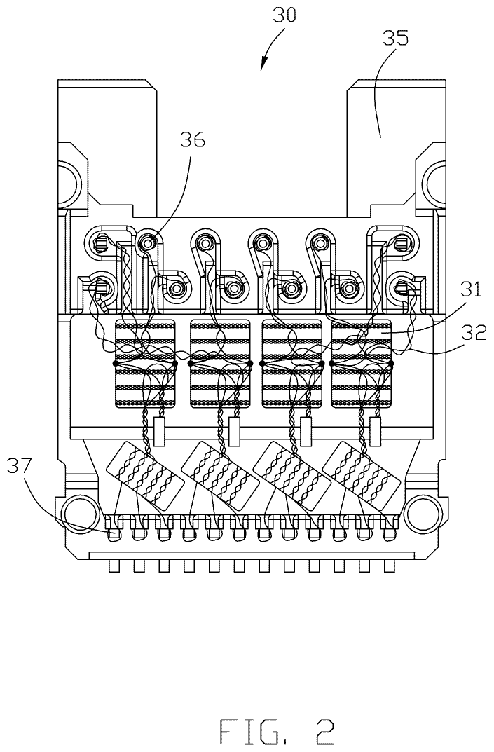

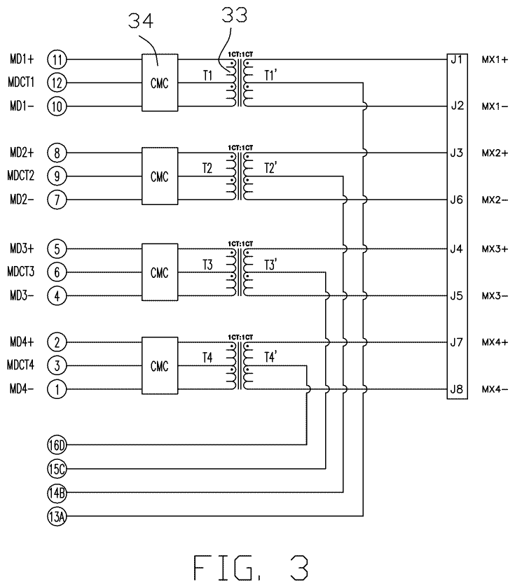

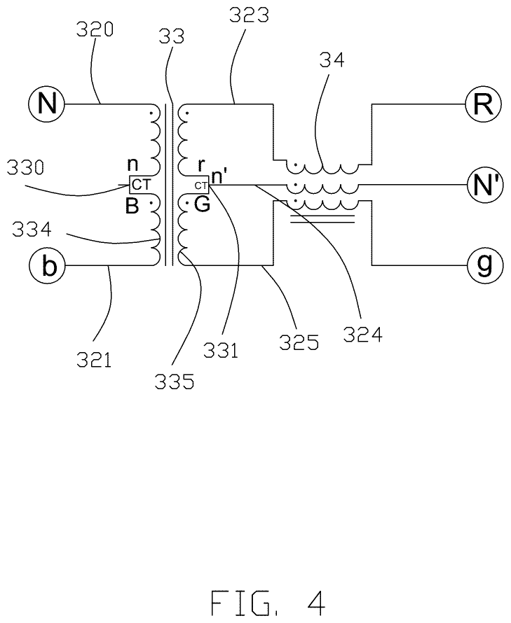

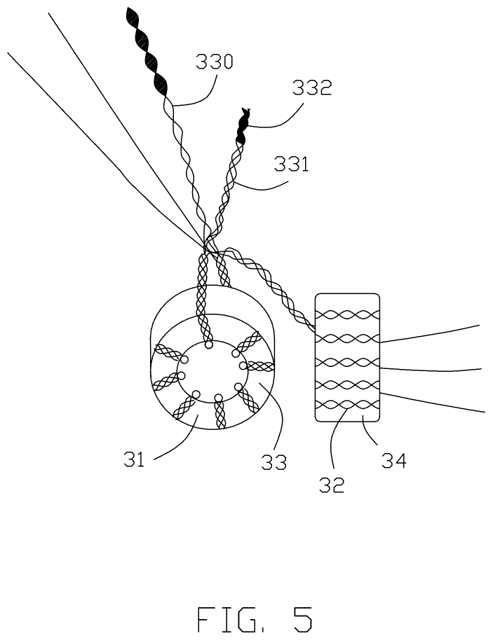

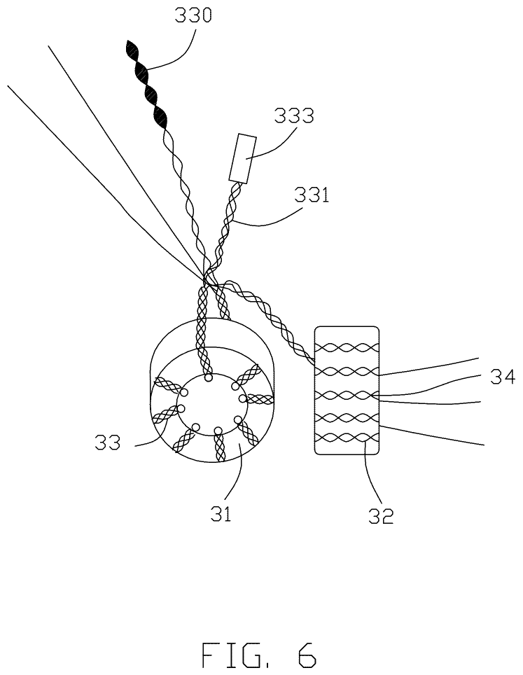

Referring to FIGS. 1-6, an electrical connector 100 in accordance with the present invention is shown. The electrical connector 100 can be mounted on an external circuit board (not shown), and can be inserted and mated by a mating connector (not shown). The electrical connector 100 includes an insulative body 10, a conductive terminal 20 received in the insulative body 10, and a magnetic coil module 30 received in the insulative body 10 and electrically connected to the conductive terminal 20. The electrical connector is an RJ45 socket connector, which includes eight conductive terminals 20 forming four pairs of transmission channels.

The magnetic coil module 30 includes a plurality of magnetic cores 31 and a plurality of enameled wires 32 wound around the magnetic cores 31. The enameled wires 32 are wound around the magnetic core 31 to form a transformer 33 and a common mode choke 34. In this embodiment, the magnetic coil module 30 includes eight separate magnetic cores 31. Four magnetic cores 31, i.e. the first magnetic cores, are wound to form the transformer 33. The other four magnetic cores 31, i.e., the second magnetic cores, are wound to form the common mode choke 34. A transformer 33 and a common mode choke 34 are electrically connected together to form a signal transmission channel and are electrically connected to the transmission channel formed by the conductive terminal 20. The transformer 33 and the corresponding common mode choke 34 play a filtering role in signal transmission, improving the signal transmission quality of the entire connector 100. The magnetic coil module 30 further includes an insulative carrier 35 for accommodating the magnetic core 31, a first set of terminals 36 and a second set of terminals 37 mounted on the insulative carrier 35.

Each transformer 33 includes a primary center tap 330 and a secondary center tap 331. The primary center tap 330 is mechanically and electrically connected to a corresponding one of the first set of terminals 36. The secondary center tap 331 includes a tinned portion 332 formed by tinning one end of two sets of enameled wires 32 to form a mechanical and electrical connection. The magnetic coil module 30 further includes an insulative member 333 coated on the tinned portion 332. Thus, the magnetic coil module 30 can withstand high voltage shock of 3KV to 8KV. Specifically, the insulative member 333 is a heat shrinkable sleeve, which is fixed on the tinned portion 332 by heat shrinking.

Each transformer 33 includes a primary coil 334 and a secondary coil 335 coupled to the primary coil 334. The primary center tap 330 is disposed on the primary coil 334. The secondary center tap 331 is disposed on the secondary coil 335.

The enameled wires 32 includes a first enameled wire 320 and a second enameled wire 321. One end of the first enameled wire 320 and one end of the second enameled wire 321 are tinned to form the primary center tap 330. The other end of the first enameled wire 320 and the other end of the second enameled wire 321 together form the input end of the signal transmission channel. The other end of the first enameled wire 320 and the other end of the second enameled wire 321 are mechanically and electrically connected to a corresponding terminal of the first set of terminals 36.

The enameled wire 32 includes a third enameled wire 323, a fourth enameled wire 324 and a fifth enameled wire 325. The third enameled wire 323 and the fifth enameled wire 325 together form the secondary coil 335. One end of the third enameled wire 323 and one end of the fifth enameled wire 325 form the secondary center tap 331. One end of the fourth enameled wire 324 is tinned with the secondary center tap 331 to form the tinned portion 332. The third enameled wire 323, the fourth enameled wire 324 and the fifth enameled wire 325 together form the common mode choke 34. The other end of the third enameled wire 323, the other end of the fourth enameled wire 324 and the other end of the fifth enameled wire 325 form the output end of the signal transmission channel. The other end of the third enameled wire 323, the other end of the fourth enameled wire 324 and the other end of the fifth enameled wire 325 are mechanically and electrically connected to a corresponding terminal of the second set of terminals 37.

In order to further improve the high voltage shock resistance of the magnetic coil module 30. The enameled wire 32 is a full insulation wire. Compared with traditional polyurethane enameled copper wire, the magnetic coil module can withstand high voltage shock.

1. A magnetic coil module comprising:
a first magnetic core;
a second magnetic core;
a plurality of enameled wires wound on the first magnetic core to form a transformer and wound on the second magnetic core to form a common mode choke, the transformer being electrically connected to the common mode choke to form a signal transmission channel, the transformer including a center tap, the center tap including a tinned portion for forming a mechanical and electrical connection with tin; and
an insulative member coated on the tinned portion to enable the magnetic coil module to withstand high voltage shock of 3KV and above.

2. The magnetic coil module as claimed in claim 1, wherein the insulative member is a heat shrinkable sleeve heat-shrunk and fixed on the tinned portion.

3. The magnetic coil module as claimed in claim 1, wherein the transformer includes a primary coil and a secondary coil coupled to the primary coil, the center tap includes a primary center tap arranged on the primary coil and a secondary center tap arranged on the secondary coil, the enameled wire comprises a first enameled wire and a second enameled wire, one end of the first enameled wire and one end of the second enameled wire are tinned to form the primary center tap, the other end of the first enameled wire and the other end of the second enameled wire together form an input end of the signal transmission channel.

4. The magnetic coil module as claimed in claim 3, wherein the enameled wire includes a third enameled wire, a fourth enameled wire, and a fifth enameled wire, the third enameled wire and the fifth enameled wire together form the secondary coil, one end of the third enameled wire and one end of the fifth enameled wire form the secondary center tap, one end of the fourth enameled wire and the primary center tap are tinned to form the tinned portion, the third enameled wire, the fourth enameled wire, and the fifth enameled wire together form the common mode choke, and the other end of the third enameled wire, the other end of the fourth enameled wire, and the other end of the fifth enameled wire form an output end of the signal transmission channel.

5. The magnetic coil module as claimed in claim 1, wherein the enameled wire is a full insulation wire to withstand high voltage shock not more than 8KV.

6. An electrical connector comprising
an insulative body;
a conductive terminal received in the insulative body; and
a magnetic coil module received in the insulative body and electrically connected to the conductive terminal; wherein
the magnetic coil module includes a magnetic core, a plurality of enameled wires wound around the magnetic core, the enameled wires being wound around the magnetic core to form a transformer and a common mode choke, the transformer and the common mode choke forming a signal transmission channel, the transformer including a primary center tap and a secondary center tap, the secondary center tap including a tinned portion in mechanical and electrical connection by tinning, and an insulative member coated on the tinned portion.

7. The electrical connector as claimed in claim 6, wherein the insulative member is a heat shrinkable sleeve heat-shrunk and fixed on the tinned portion.

8. The electrical connector as claimed in claim 6, wherein the transformer includes a primary coil and a secondary coil coupled to the primary coil, the primary center tap is arranged on the primary coil, and the secondary center tap is arranged on the secondary coil, the enameled wire comprises a first enameled wire and a second enameled wire, one end of the first enameled wire and one end of the second enameled wire are tinned to form the primary center tap, and the other end of the first enameled wire and the other end of the second enameled wire together form an input end of the signal transmission channel.

9. The electrical connector as claimed in claim 8, wherein the enameled wire includes a third enameled wire, a fourth enameled wire, and a fifth enameled wire, the third enameled wire and the fifth enameled wire together form the secondary coil, one end of the fourth enameled wire and the primary center tap are tinned to form the tinned portion, the third enameled wire, the fourth enameled wire, and the fifth enameled wire together form the common mode choke, and the other end of the third enameled wire and the other end of the fifth enameled wire form an output end of the signal transmission channel.

10. The electrical connector as claimed in claim 6, wherein the enameled wire is a full insulation wire to withstand high voltage shock from 3KV to 8KV.

11. The electrical connector as claimed in claim 6, wherein the terminal module includes an insulative carrier, a first set of terminals and a second set of terminals mounted on the insulative carrier, the magnetic coil module is received on the insulative carrier, one end of the first enameled wire, one end of the second enameled wire, and the primary center tap are mechanically and electrically connected to the first set of terminals, the other end of the third enameled wire, the other end of the fourth enameled wire, and the other end of the fifth enameled wire are mechanically and electrically connected to the second set of terminals.
